(19) United States
(12) Patent Application Publication
(10) Pub. No.: US 2026/0071813 A1
(43) Pub. Date: Mar. 12, 2026

(54) EFFICIENT COLD-BREWED COFFEE DEVICE AND COLD BREW COOLING METHOD

(71) Applicant: Meizhou Huashenghui Technology Co., Ltd., Meizhou (CN)

(72) Inventor: ZHONGHUI GU, Meizhou (CN)

(21) Appl. No.: 19/015,672

(22) Filed: Jan. 10, 2025

(30) Foreign Application Priority Data
Sep. 10, 2024 (CN) 2024112604504

(51) Int. Cl. F25D 31/00; A47J 31/44; A47J 31/52

(52) U.S. Cl. CPC F25D 31/002; A47J 31/4425; A47J 31/5253

(57) ABSTRACT

Provided in the present disclosure are an efficient cold-brewed coffee device and a cold brew cooling method. A base of the device is provided with an extraction assembly and a cup holder assembly. The extraction assembly is connected to an extraction water path. The extraction water path is connected to a second heat exchange device. The cup holder assembly includes a first heat exchange device configured to perform heat exchange and cooling on a coffee cup on the cup holder assembly. During extraction, the second heat exchange device cools the liquid in the extraction water path. During collection and storage of coffee liquid, the first heat exchange device cools the coffee cup. According to the present disclosure, the drinking taste of cold-brewed coffee can be ensured, and the use of water cooling circuits can not only improve the heat dissipation efficiency, but also reduce noise

### CROSS REFERENCE TO RELATED APPLICATIONS

The present application claims the priority of Chinese patent application No. 2024112604504, filed on Sep. 10, 2024, and contents of which are incorporated herein by reference.

### FIELD OF TECHNOLOGY

The present disclosure relates to the technical field of coffee preparation, specifically to an efficient cold-brewed coffee device and a cold brew cooling method.

### BACKGROUND

Compared with conventional hot-brewed coffee, cold-brewed coffee can better preserve the aroma and flavor in coffee beans, making the coffee taste mellower and softer. Meanwhile, the cold-brewed coffee also features low acidity and low caffeine content. Therefore, it has gained popularity among people. The cold-brewed coffee is prepared by a cold-brewed coffee maker. The existing cold-brewed coffee maker refrigerates drinking water and obtains coffee liquid through a pulsed extraction technology.

To obtain drinking water with a low temperature, the existing cold-brewed coffee maker refrigerates and cools the drinking water by a refrigeration module. However, the refrigeration module will generate a large amount of heat while refrigerating the drinking water. If the heat cannot be dissipated, the refrigeration efficiency of the refrigeration module will be affected. In view of this, most existing cold-brewed coffee makers take away the heat of the refrigeration module by using cooling fins and a fan. For example, the utility model patent No. CN220236638U discloses a multifunctional coffee maker in which a refrigeration module is provided. The refrigeration module can refrigerate water and is controlled by a cold water solenoid valve to achieve opening and closing of cold water, so as to achieve brewing of cold coffee. The refrigeration module includes a semiconductor refrigeration chip, a cold dissipation plate, a heat dissipation base, and a heat dissipation fan. Under the action of the heat dissipation fan, outside air enters an accommodating cavity and blows towards the heat dissipation base to achieve cooling, and then heated air is discharged into the outside air.

However, the use of the cooling fins and the heat dissipation fan in such structure has low heat dissipation efficiency and high cost, and affects heat dissipation of the refrigeration module, thus affecting the refrigeration efficiency of the refrigeration module, and making it difficult to ensure the taste of cold-brewed coffee liquid. Meanwhile, the cooling fins and the heat dissipation fan have a large size, thus limiting their mounting positions in the cold-brewed coffee maker, and being unfavorable for design of a miniaturized coffee maker. Moreover, the dissipation of heat by the cooling fins and the heat dissipation fan results in loud noise and poor user experience.

In addition, after the existing cold-brewed coffee is prepared, the temperature of the coffee liquid rises up quickly, affecting the taste during drinking. The lack of effective heat preservation measures also affects the user experience.

The above deficiencies are worthy of being overcome.

### SUMMARY

To overcome the deficiencies in the prior art, the present disclosure provides an efficient cold-brewed coffee device and a cold brew cooling method. Two heat exchange devices are used to refrigerate drinking water and to refrigerate and keep coffee liquid warm respectively, thus ensuring the drinking taste of cold-brewed coffee. Meanwhile, water cooling circuits are used to achieve heat exchange of the heat exchange devices respectively, which can not only enhance the heat dissipation efficiency, but also reduce noise, save space, and improve user experience.

The technical solutions of the present disclosure are as follows:

An efficient cold-brewed coffee device includes a base, where the base is provided with:
an extraction assembly connected to an extraction water path, where the extraction water path is connected to one or more second heat exchange devices, and the second heat exchange device is configured to perform heat exchange and cooling on liquid in the extraction water path and dissipate heat after heat exchange by means of water cooling; and
a cup holder assembly including a first heat exchange device configured to perform heat exchange and cooling on a coffee cup on the cup holder assembly and dissipate heat after heat exchange by means of water cooling.

According to the present disclosure using the above solution, the second heat exchange device includes a refrigeration component and a second cooling plate, where the extraction water path passes through the refrigeration component, the refrigeration component is connected to a cold end of the second cooling plate and is configured to cool the liquid in the extraction water path by the second cooling plate, and a hot end of the second cooling plate is connected to a water cooling circuit.

Further, the water cooling circuit is provided with a second heat exchange component, and the second heat exchange component is connected to the hot end of the second cooling plate and is configured to absorb heat of the second cooling plate.

According to the present disclosure using the above solution, the first heat exchange device includes a first cooling plate, where a cold end of the first cooling plate is connected to a bottom support plate of the cup holder assembly and is configured to cool the bottom support plate by the first cooling plate, and a hot end of the first cooling plate is connected to a water cooling circuit.

Further, the water cooling circuit is provided with a first heat exchange component, and the first heat exchange component is connected to the hot end of the first cooling plate and is configured to absorb heat of the first cooling plate.

According to the present disclosure using the above solution, the base is provided with a cooling water tank;
a water cooling circuit in the first heat exchange device is connected in series to a water cooling circuit in the second heat exchange device, and two ends of a circuit are connected to a water outlet connector and a water inlet connector of the cooling water tank;
alternatively, the water cooling circuit in the first heat exchange device is connected in parallel to the water cooling circuit in the second heat exchange device, so that two ends of the water cooling circuit in the first heat exchange device are connected to the water outlet connector and the water inlet connector of the cooling water tank, and two ends of the water cooling circuit in the second heat exchange device are connected to the water outlet connector and the water inlet connector of the cooling water tank.

Further, the cooling water tank includes an outlet water tank and an inlet water tank, where the outlet water tank is connected to a cold water inlet of the water cooling circuit in the first heat exchange device and a cold water inlet of the water cooling circuit in the second heat exchange device, and the inlet water tank is connected to a hot water outlet of the water cooling circuit in the first heat exchange device and a hot water outlet of the water cooling circuit in the second heat exchange device.

In another aspect, a cold brew cooling method for an efficient cold-brewed coffee device is provided, where based on the above efficient cold-brewed coffee device, the cold brew cooling method includes:
during extraction, cooling liquid in an extraction water path by a second heat exchange device to an extraction temperature; and during collection and storage of coffee liquid, cooling a coffee cup on a cup holder assembly by a first heat exchange device to a storage temperature.

According to the present disclosure using the above solution, during the extraction, the extraction temperature is determined, and a second cooling plate is controlled based on the extraction temperature to cool liquid flowing through a refrigeration component, so that the liquid in the extraction water path reaches a required temperature; and meanwhile, liquid flowing through a water cooling circuit with a second heat exchange component is driven to circulate, so as to perform heat exchange on the second cooling plate by the second heat exchange component.

According to the present disclosure using the above solution, during the collection and storage of the coffee liquid, the collection and storage temperature of the coffee liquid is determined, and a first cooling plate is controlled based on the temperature to cool a bottom support plate in the cup holder assembly, so that the coffee liquid in the coffee cup on the bottom support plate is stabilized at a required temperature; and meanwhile, liquid flowing through a water cooling circuit with a first heat exchange component is driven to circulate, so as to perform heat exchange on the first cooling plate by the first heat exchange component.

The present disclosure using the above solution has the following beneficial effects:

According to the present disclosure, the second cooling plate is used to refrigerate drinking water, and the first cooling plate is used to refrigerate the base where the coffee cup is placed, which can not only achieve cold brewing of the coffee liquid, but also ensure the storage temperature of the cold-brewed coffee liquid, enabling the coffee liquid to maintain the best drinking taste for a long time.

According to the present disclosure, the water cooling circuits are used to achieve heat dissipation and cooling of the first cooling plate and the second cooling plate respectively, so that not only can the heat of the cooling plates be taken away, but also the water cooling heat dissipation has the advantages of low cost and small size, which is beneficial to production and application. Meanwhile, compared with conventional air cooling heat dissipation, the water cooling heat dissipation improves the heat dissipation efficiency, is conducive to noise control, and improves user experience.

### BRIEF DESCRIPTION OF THE DRAWINGS

FIG. 1 is a schematic structural diagram of the present disclosure;

FIG. 2 is a schematic diagram of an extraction assembly in an opened state according to the present disclosure;

FIG. 3 is a top view of the present disclosure;

FIG. 4 is a partial sectional view along a direction A-A in FIG. 3;

FIG. 5 is an exploded view of a cup holder assembly in the present disclosure;

FIG. 6 is a sectional view of a first heat exchange component in the present disclosure;

FIG. 7 is a partial sectional view along a direction B-B in FIG. 3;

FIG. 8 is a schematic diagram of an extractive refrigeration part in the present disclosure;

FIG. 9 is a schematic diagram of an extractive refrigeration part in the present disclosure from another perspective;

FIG. 10 is an exploded view of a circuit board assembly and a first extractive refrigeration part in the present disclosure;

FIG. 11 is a sectional view of a cold absorption component in the present disclosure; and

FIG. 12 is a partial sectional view along a direction C-C in FIG. 3.

In the drawings, reference numerals are as follows:
10. base;
20. cooling water tank; 21. outlet water tank; 22. inlet water tank; 23. partition; 24. reflux channel; 25. water outlet connector; 26. water inlet connector;
30. drinking water tank; 31. water tank connector;
401. first pipeline; 402. second pipeline; 403. third pipeline; 404. fourth pipeline; 405. fifth pipeline; 406. sixth pipeline; 407. seventh pipeline; 408. eighth pipeline; 409. ninth pipeline; 410. tenth pipeline; 411. eleventh pipeline;
50. extraction assembly; 51. extraction container; 52. extraction connector; 53. coffee cup;
61. bottom support bracket; 611. bracket accommodating cavity; 62. bottom support cover; 621. cover accommodating cavity; 622. cover through hole; 63. first heat exchange component; 631. heat exchange body; 632. heat exchange water inlet; 633. heat exchange pipeline; 634. heat exchange water outlet; 64. first water pump; 65. first cooling plate; 66. bottom support plate;
70. second heat exchange device; 71. first heat exchange bracket; 72. first heat insulation layer; 73. refrigeration component; 731. refrigeration body; 732. refrigeration water inlet; 733. refrigeration pipeline; 734. refrigeration water outlet; 74. second cooling plate; 75. second heat exchange component; 76. second heat insulation layer; 77. second heat exchange bracket;
80. third heat exchange device; 801. second water pump; 802. third water pump;
90. circuit board assembly; 91. circuit board bracket; 92. main PCB; 93. motor PCB; and 94. button.

### DETAILED DESCRIPTION OF THE EMBODIMENTS

The present disclosure is further described below in conjunction with the accompanying drawings and embodiments.

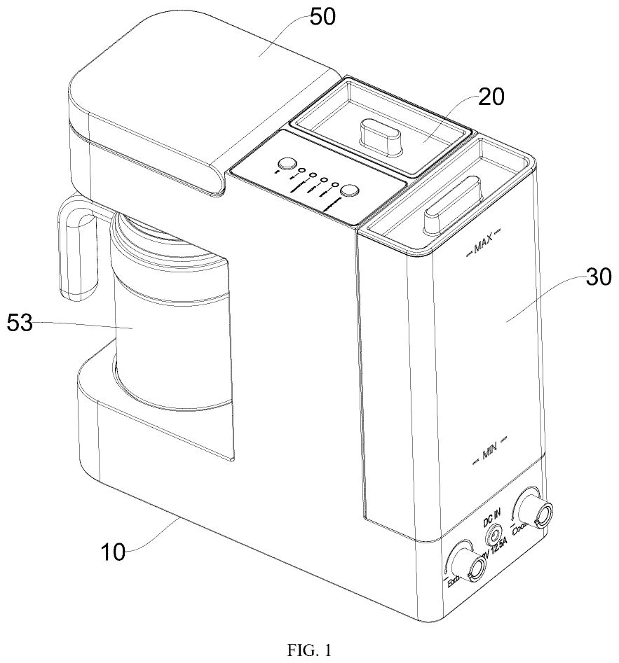

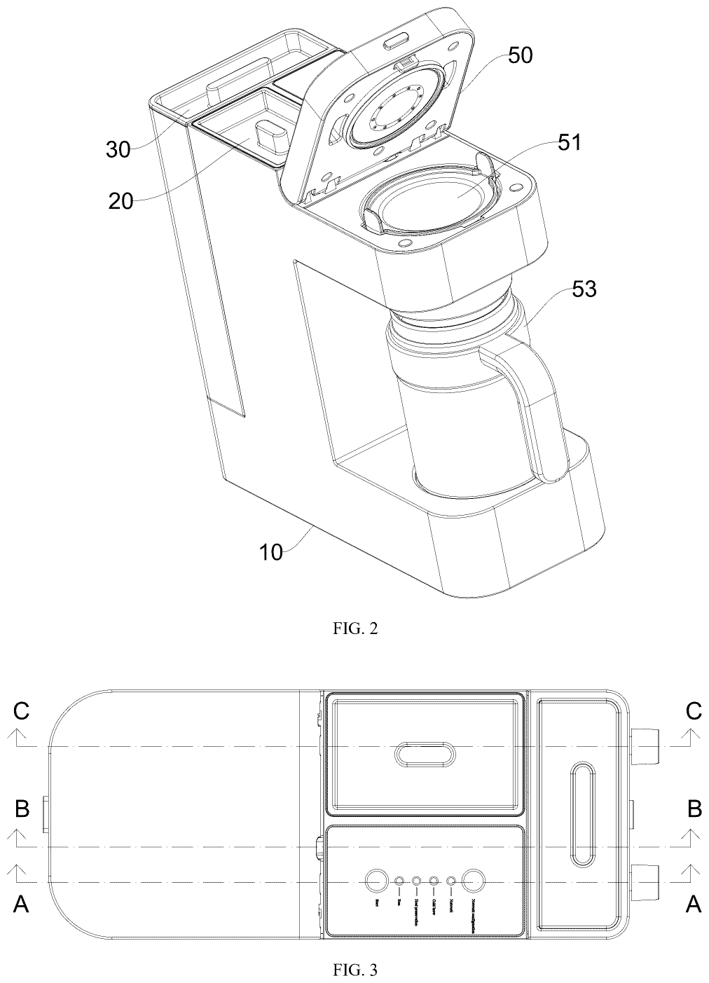

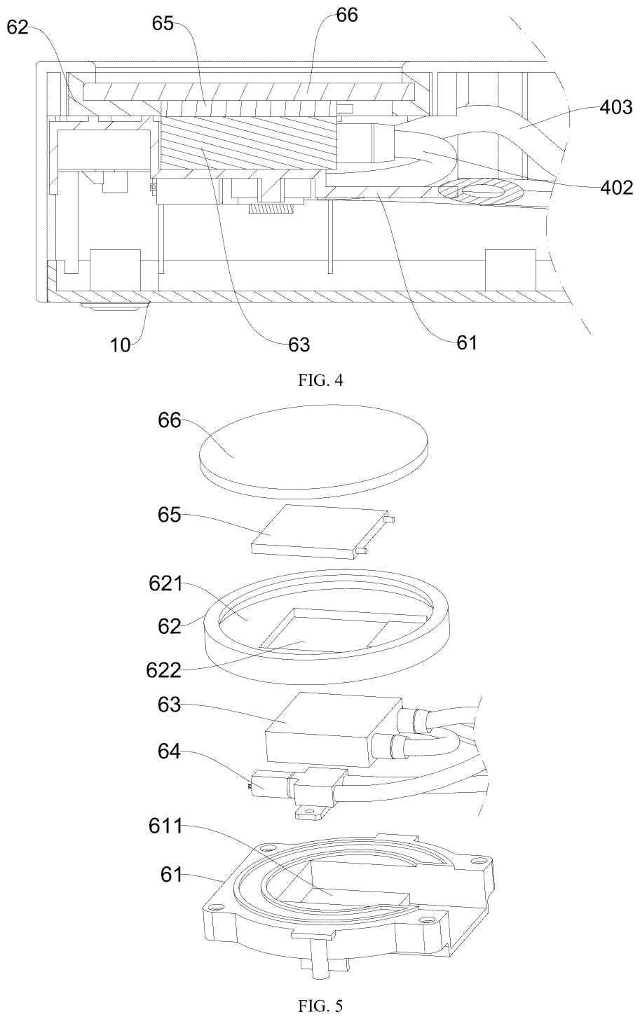

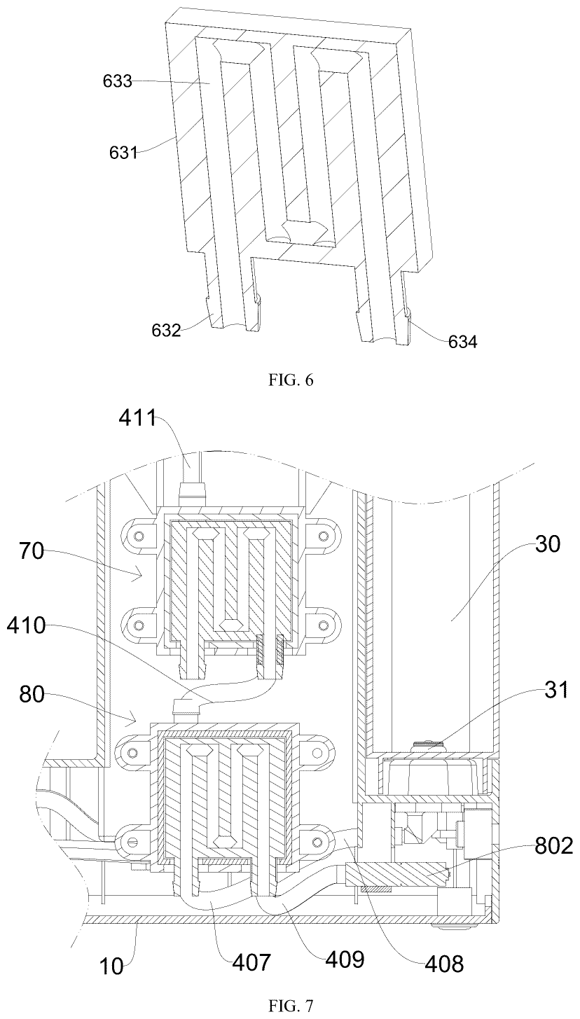

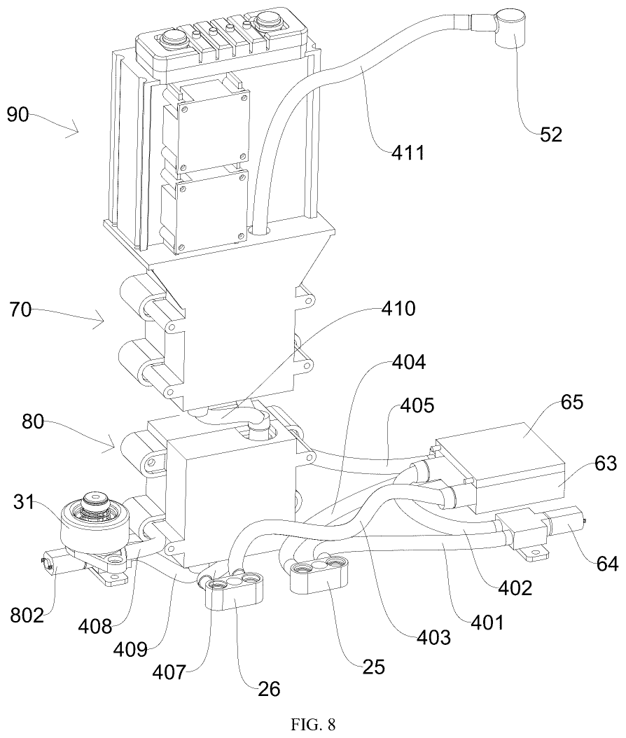

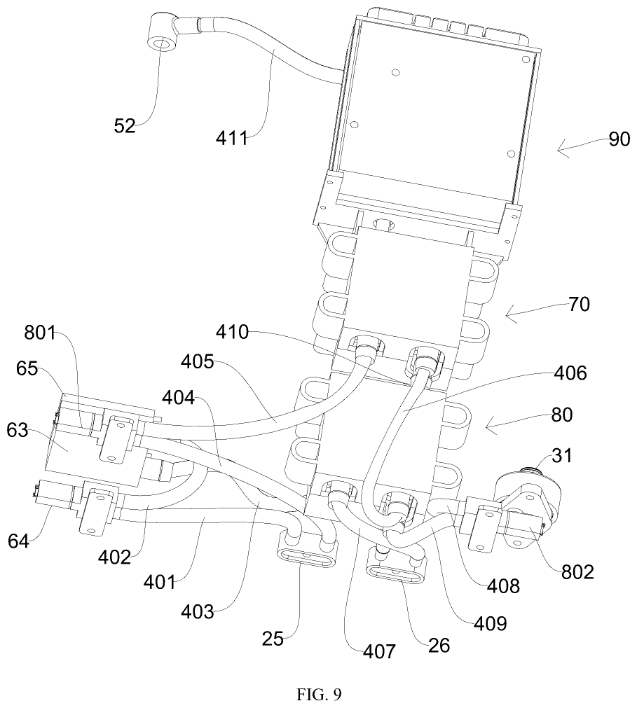

As shown in FIG. 1 to FIG. 12, the present disclosure proposes an efficient cold-brewed coffee device, to solve the problems such as low efficiency of cold brewing temperature and poor taste caused by rapid temperature rise of coffee liquid after cold brewing in an existing cold-brewed coffee maker. First, liquid in an extraction water path is refrigerated, and heat dissipation and cooling are performed by a second heat exchange device, thus achieving efficient extraction. In addition, a coffee cup on a cup holder assembly is refrigerated to ensure that the cold-brewed coffee liquid stored in the coffee cup remains at the optimal temperature, and heat dissipation and cooling are performed by a first heat exchange device to achieve temperature balance.

The efficient cold-brewed coffee device includes a base 10. The base 10 is provided with an extraction assembly 50 and a cup holder assembly. The base 10 serves as a hardware support foundation for the entire cold-brewed coffee device. The extraction assembly 50 is configured to perform cold brewing on coffee powder to form coffee liquid. The cup holder assembly is disposed on a lower side of the extraction assembly 50 and is configured to place a coffee cup 53 and receive the cold-brewed coffee liquid. A circuit board assembly 90 configured to control operation of the entire efficient cold-brewed coffee device is further disposed in the base 10. The circuit board assembly 90 includes a circuit board bracket 91, a main PCB 92, a motor PCB 93, and buttons 94. The main PCB 92, the motor PCB 93, and the buttons 94 are all assembled on the circuit board bracket 91 and are mounted on the base 10 by the circuit board bracket 91. In the present disclosure, the main PCB 92 configured to achieve centralized control on system functions is separated from the motor PCB 93 configured to control operation of a water pump. First, an internal space of the circuit board bracket 91 can be effectively utilized. Secondly, the functions can be mutually independent, and the stability of system operation can be ensured.

Specifically, as shown in FIG. 3 and FIG. 7 to FIG. 11, in a structure for preparing the cold-brewed coffee liquid, the extraction assembly 50 is connected to an extraction water path, the extraction water path is connected to a drinking water tank 30 and is provided with a third water pump 802, and the third water pump 802 is configured to pump liquid in the drinking water tank 30 into the extraction assembly 50 via the extraction water path. The cooled liquid in the extraction water path flows to a position of the extraction assembly 50 for preparation of cold-brewed coffee. To cool the liquid in the extraction water path, in the present disclosure, the extraction water path is connected to one or more second heat exchange devices, and the second heat exchange device is configured to perform heat exchange and cooling on the liquid in the extraction water path. The second heat exchange device is further configured to perform water-cooling heat dissipation on heat after heat exchange, so that the heat after heat exchange with the liquid in the extraction water path can be dissipated.

The extraction water path is connected to two second heat exchange devices, specifically a second heat exchange device 70 and a third heat exchange device 80. The second heat exchange device 70 and the third heat exchange device 80 can improve absorption and dissipation of heat by water cooling circuits, and ensure the cooling effect. During specific implementation, the second heat exchange device 70 and the third heat exchange device 80 can refrigerate the extraction water path located at the same position, and can also sequentially refrigerate different positions along the extension of the extraction water path. A choice can be made based on specific circumstances.

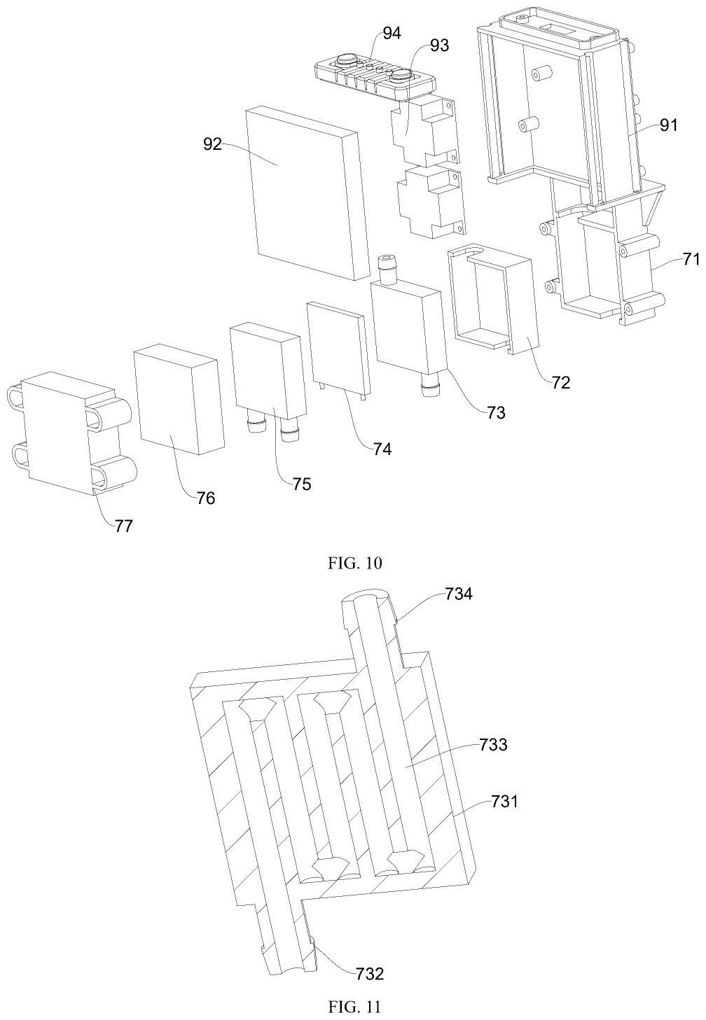

The second heat exchange device 70 and the third heat exchange device 80 are similar in structure. Taking the second heat exchange device 70 as an example, with reference to FIG. 10 and FIG. 11, the second heat exchange device 70 includes a refrigeration component 73 and a second cooling plate 74. The extraction water path passes through the refrigeration component 73. The refrigeration component 73 is connected to a cold end of the second cooling plate 74 and is configured to cool the liquid in the extraction water path by the second cooling plate 74. A hot end of the second cooling plate 74 is connected to a water cooling circuit. To ensure full dissipation of heat of the second cooling plate 74 by the water cooling circuit, in this embodiment, the water cooling circuit is provided with a second heat exchange component 75, and the second heat exchange component 75 is connected to the hot end of the second cooling plate 74 and is configured to absorb the heat of the second cooling plate 74. In the present disclosure, the second cooling plate 74 directly cools the liquid in the refrigeration component 73, thereby achieving faster and more stable cooling, and improving the efficiency of preparing the cold-brewed coffee liquid. In the present disclosure, the second heat exchange component 75 is used to perform heat dissipation and cooling on the second cooling plate 74, which can ensure the working stability of the second cooling plate 74 so as to achieve better refrigeration efficiency.

To ensure that the second cooling plate 74 fully refrigerates liquid flowing through the refrigeration component 73 and that the second heat exchange component 75 exchanges heat at the hot end of the second cooling plate 74, in this embodiment, a first heat insulation layer 72 is disposed on an outer side of the refrigeration component 73, and a second heat insulation layer 76 is disposed on an outer side of the second heat exchange component 75. The first heat insulation layer 72 and the second heat insulation layer 76 are configured to ensure full transfer of internal cold and heat. Preferably, the second cooling plate 74 is a semiconductor cooler connected to the circuit board assembly 90 (specifically referring to the main PCB 92) in the base 10. The main PCB 92 in the circuit board assembly 90 controls a working state of the semiconductor cooler to achieve control on a refrigeration temperature of the cold-brewed liquid.

In addition, in this embodiment, the second heat exchange device 70 further includes a first heat exchange bracket 71 and a second heat exchange bracket 77, where the first heat exchange bracket 71 is located on the peripheries of a refrigeration body and the first heat insulation layer 72, the second heat exchange bracket 77 is located on the peripheries of the second heat exchange component 75 and the second heat insulation layer 76, and the first heat exchange bracket 71 and the second heat exchange bracket 77 are assembled and fixed together to fix the entire second heat exchange device 70 inside the base 10. Through the application of the first heat exchange bracket 71 and the second heat exchange bracket 77, in this embodiment, the second heat exchange device can be directly assembled as a complete module, thereby achieving a higher integration level of the second heat exchange device.

As shown in FIG. 11, to increase a contact area and contact time between the second cooling plate 74 and the cold-brewed liquid and to ensure full cooling of the cold-brewed liquid in the refrigeration component 73, the refrigeration component 73 in this embodiment is provided with a channel for increasing the contact area. Specifically, the refrigeration component 73 includes a refrigeration body 731 and a refrigeration pipeline 733 located inside the refrigeration body 731, where two ends of the refrigeration pipeline 733 are provided with a refrigeration water inlet 732 and a refrigeration water outlet 734 respectively. The cold-brewed liquid enters the refrigeration body 731 through the refrigeration water inlet 732, turns back under the guidance of the refrigeration pipeline 733, and flows out through the refrigeration water outlet 734. The corresponding second heat exchange component 75 is also provided with a channel for extending the path. Reference is made to the following description of the cup holder assembly.

During flow of the cold-brewed liquid, the second heat exchange device 70 and the third heat exchange device 80 are sequentially connected in series to achieve driving and cooling of liquid in a cold brewing loop. A water tank connector 31 of the drinking water tank 30 is connected to the third water pump 802 through an eighth pipeline 408. The third water pump 802 is connected to the third heat exchange device 80 through a ninth pipeline 409. The third heat exchange device 80 is connected to the second heat exchange device 70 through a tenth pipeline 410. The second heat exchange device 70 is connected to an extraction connector 52 of the extraction assembly 50 through an eleventh pipeline 411. The cold-brewed liquid falls into an extraction container 51 in the extraction assembly 50 via the extraction connector 52 and falls into the coffee cup 53 located on a lower side of the extraction container 51.

Specifically, as shown in FIG. 3 to FIG. 6 and FIG. 12, in a structure for collecting and storing the cold-brewed coffee liquid, the cup holder assembly includes a first heat exchange device. The first heat exchange device is configured to perform heat exchange and cooling on the coffee cup on the cup holder assembly, so that the coffee liquid in the coffee cup maintains the optimal drinking temperature to ensure the taste of the coffee liquid.

The first heat exchange device includes a first cooling plate 65, where a cold end of the first cooling plate 65 is connected to a bottom support plate 66 of the cup holder assembly and is configured to cool the bottom support plate 66 by the first cooling plate 65, and the first cooling plate 65 is a semiconductor cooler connected to the circuit board assembly 90 (specifically referring to the main PCB 92) in the base 10. The first heat exchange device further includes a water cooling circuit, where a hot end of the first cooling plate 65 is connected to the water cooling circuit and is configured to perform water-cooling heat dissipation on heat after heat exchange by the water cooling circuit. In the present disclosure, the first cooling plate 65 and the bottom support plate 66 are used to directly refrigerate and cool the coffee cup, which can ensure that the coffee liquid in the coffee cup is at a temperature for the optimal taste, and that the temperature distribution is more balanced. Meanwhile, the water cooling circuit is used to perform heat dissipation and cooling on the first cooling plate 65, thereby ensuring the working stability of the first cooling plate 65, and keeping it in the optimal working state.

To ensure full dissipation of heat of the first cooling plate 65 by the water cooling circuit, in this embodiment, the water cooling circuit is provided with a first heat exchange component 63, and the first heat exchange component 63 is connected to the hot end of the first cooling plate 65 and is configured to absorb the heat of the first cooling plate 65. To ensure the refrigeration and cooling effects of the first cooling plate 65 on the coffee cup, the cup holder assembly in this embodiment includes a bottom support plate 66. The bottom support plate 66 is in contact with the first cooling plate 65 and can spread the temperature of the cooling plate to increase the contact area with the coffee cup and ensure the temperature uniformity. Preferably, the bottom support plate 66 is made of metal (e.g., aluminum, which is lightweight), can conduct heat more effectively, and has low cost.

To improve the heat exchange efficiency of the first heat exchange component 63 and the second heat exchange component 75, channels for increasing a heat exchange area of the liquid are formed inside the first heat exchange component 63 and the second heat exchange component 75 in this embodiment. As shown in FIG. 11, taking the first heat exchange component 63 as an example, the first heat exchange component 63 includes a heat exchange body 631, where a heat exchange pipeline 633 is disposed inside the heat exchange body 631, and two ends of the heat exchange pipeline 633 are provided with a heat exchange water inlet 632 and a heat exchange water outlet 634 respectively. Liquid (e.g., water) for heat exchange enters the heat exchange body 631 via the heat exchange water inlet 632, turns back under the guidance of the heat exchange pipeline 633, and flows out via the heat exchange water outlet 634.

The first heat exchange device further includes a bottom support bracket 61, where the bottom support bracket 61 is configured to mount and fix the first heat exchange component 63. Specifically, a concave bracket accommodating cavity 611 is formed in a middle of the bottom support bracket 61, and the first heat exchange component 63 is mounted in the bracket accommodating cavity 611.

The first heat exchange device further includes a bottom support cover 62, where the bottom support cover 62 is mounted on the bottom support bracket 61, and the bottom support cover 62 is configured to mount the first heat exchange component 63 and the first cooling plate 65. Specifically, the bottom support cover 62 is provided with a cover accommodating cavity 621, and the cover accommodating cavity 621 is configured to fixedly mount the bottom support plate 66; and a cover through hole 622 that is through from top to bottom is further formed in a middle of the bottom support cover 62, and the first cooling plate 65 is mounted at a position of the cover through hole 622, so that the first cooling plate 65 can be in contact with the bottom support plate 66 and the first heat exchange component 63 separately.

In the present disclosure, the specific structural design of the first heat exchange device enables the first heat exchange device to have a higher integration level, which can fully reduce the size of the base, better facilitate assembly, and achieve the function of the first heat exchange device.

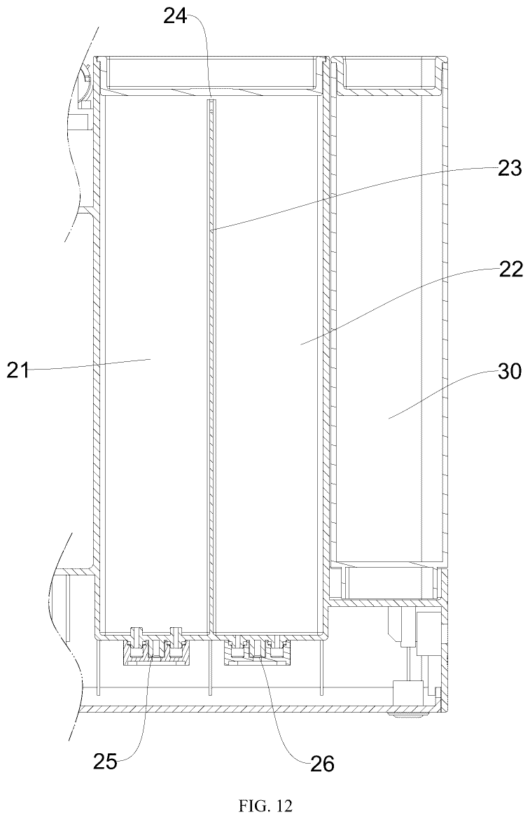

As shown in FIG. 3 and FIG. 12, the base 10 is provided with a cooling water tank 20, and the cooling water tank 20 is configured to store cooling liquid and achieve circulating flow of the liquid. The cooling water tank 20 in the present disclosure can directly store cooling water, and can achieve heat dissipation and cooling of each cooling plate through water circulation; and the cooling water tank in the present disclosure can also store other cooling liquids. The present disclosure is not limited to the water.

The cooling water tank 20 includes an outlet water tank 21 and an inlet water tank 22, where the outlet water tank 21 is connected to a cold water inlet of the water cooling circuit in the first heat exchange device and a cold water inlet of the water cooling circuit in the second heat exchange device, and the inlet water tank 22 is connected to a hot water outlet of the water cooling circuit in the first heat exchange device and a hot water outlet of the water cooling circuit in the second heat exchange device. Specifically, a water outlet position of the outlet water tank 21 is provided with a water outlet connector 25, and the water outlet connector 25 is connected to the cold water inlet of the water cooling circuit in the first heat exchange device and the cold water inlet of the water cooling circuit in the second heat exchange device; and a water inlet position of the inlet water tank 22 is provided with a water inlet connector 26, and the water inlet connector 26 is connected to the hot water outlet of the water cooling circuit in the first heat exchange device and the hot water outlet of the water cooling circuit in the second heat exchange device.

The outlet water tank 21 and the inlet water tank 22 are separated by a partition 23, and one end of the outlet water tank 21 away from the water outlet position communicates with one end of the inlet water tank 22 away from the water inlet position. Specifically, a top of the partition 23 is provided with a gap, the gap forms a reflux channel 24 that connects the inlet water tank 22 to the outlet water tank 21, and liquid in the inlet water tank 22 flows into the outlet water tank 21 via the reflux channel 24. In the present disclosure, the structural design of the cooling water tank 20 can increase a flow distance of the cooling liquid in the cooling water tank 20, so that high-temperature liquid fully dissipates heat before being reused and absorbs heat at the positions of the first heat exchange device and the second heat exchange device.

In the present disclosure, the first heat exchange device and the second heat exchange device can use the same water cooling circuit. That is, during one-time circulation, the cooling liquid flows through the first heat exchange device and the second heat exchange device in sequence (or the cooling liquid can flow through the second heat exchange device first and then flow through the first heat exchange device), so as to achieve cooling and storage of the coffee liquid in the coffee cup by the first heat exchange device and refrigeration of the cold-brewed liquid by the second heat exchange device. For example, in a first specific embodiment, the water cooling circuit in the first heat exchange device is connected in series to the water cooling circuit in the second heat exchange device, and two ends of a series-connected circuit are connected to the water outlet connector and the water inlet connector of the cooling water tank. In this embodiment, driving of the liquid can be achieved using one water pump in the entire water cooling circuit.

In the present disclosure, the first heat exchange device and the second heat exchange device can also use different water cooling circuits. That is, the water cooling circuits used for the first heat exchange device and the second heat exchange device are connected “in parallel”. For example, in a second specific embodiment, the water cooling circuit in the first heat exchange device is connected in parallel to the water cooling circuit in the second heat exchange device, so that two ends of the water cooling circuit in the first heat exchange device are connected to the water outlet connector and the water inlet connector of the cooling water tank 20, and two ends of the water cooling circuit in the second heat exchange device are connected to the water outlet connector 25 and the water inlet connector 26 of the cooling water tank 20. In this embodiment, the water cooling circuit where the first heat exchange device is located is provided with a first water pump 64 configured to drive the liquid to circulate, and the first water pump 64 is connected to the motor PCB 93; and the water cooling circuit where the second heat exchange device (including the third heat exchange device) is located is provided with a second water pump 801 configured to drive the liquid to circulate, and the second water pump 801 is connected to the motor PCB 93.

In a second specific embodiment, taking the case that the second heat exchange device and the third heat exchange device are included as an example, the components are connected by pipelines, where the water outlet connector 25 of the cooling water tank 20 is connected to the first water pump 64 by a first pipeline 401, a water outlet end of the first water pump 64 is connected to the first heat exchange component 63 in the first heat exchange device by a second pipeline 402, and a water outlet end of the first heat exchange component 63 is connected to the water inlet connector 26 of the cooling water tank 20 by a third pipeline 403; and the water outlet connector 25 of the cooling water tank 20 is also connected to the second water pump 801 by a fourth pipeline 404, a water outlet end of the second water pump 801 is connected to the second heat exchange component 75 in the second heat exchange device by a fifth pipeline 405, a water outlet end of the second heat exchange component 75 is connected to the second heat exchange component 75 in the third heat exchange device by a sixth pipeline 406, and the water outlet end of the second heat exchange component 75 is connected to the water inlet connector 26 of the cooling water tank 20 by a seventh pipeline 407.

In this embodiment, the cooling liquid returns to the cooling water tank 20 after passing through the second heat exchange device 70 and the third heat exchange device 80 in sequence, and the drinking water enters the extraction assembly 50 after passing through the third heat exchange device 80 and the second heat exchange device 70 in sequence, so that a flow direction of the cooling liquid in the second heat exchange device 70 and the third heat exchange device 80 is opposite to a flow direction of the drinking water in the second heat exchange device 70 and the third heat exchange device 80, the drinking water can be fully cooled during refrigeration, and full heat dissipation of the second cooling plate 74 in the second heat exchange device 70 and the third heat exchange device 80 is achieved. In other embodiments, the flow direction of the cooling liquid in the second heat exchange device 70 and the third heat exchange device 80 can also be the same as that of the drinking water in the second heat exchange device 70 and the third heat exchange device 80.

In the present disclosure, the water cooling circuit where the first heat exchange device is located and the water cooling circuit where the second heat exchange device (including the second heat exchange device 70 and the third heat exchange device 80) is located are used for water cooling, so that the heat of the first cooling plate and the second cooling plate is effectively dissipated. On the one hand, the two cooling plates can be used to achieve more efficient refrigeration during the preparation and storage of the cold-brewed coffee, thus ensuring the taste of the coffee. On the other hand, the water cooling circuits can be used to achieve rapid heat dissipation without causing noise in the entire coffee maker, thus improving the user experience.

Additionally, in the present disclosure, the structural design of the first heat exchange device and the second heat exchange device achieves higher integration of a cooling structure in the entire coffee cup, which not only benefits the production and assembly of the coffee cup, but also can fully reduce the size of the heat exchange devices in the coffee maker to achieve a miniaturized design.

Based on the above efficient cold-brewed coffee device, the present disclosure further provides a cold brew cooling method for an efficient cold-brewed coffee device. The cold brew cooling method includes a step of cooling during extraction and a step of cooling during collection and storage of coffee liquid. During the extraction, a second heat exchange device cools liquid in an extraction water path to an extraction temperature; and during the collection and storage of the coffee liquid, a first heat exchange device cools a coffee cup on a cup holder assembly to a storage temperature.

During the extraction, the extraction temperature is determined, and a second cooling plate is controlled based on the extraction temperature to cool liquid flowing through a refrigeration component, so that the liquid in the extraction water path reaches a required temperature. During the process, a temperature sensor is used to detect a temperature of the liquid in the extraction water path in real time, and a closed-loop circuit in a main PCB is used to achieve closed-loop control on a temperature of the second cooling plate.

The motor PCB drives the liquid flowing through the water cooling circuit with the second heat exchange component to circulate by the second water pump, so as to perform heat exchange on the second cooling plate by the second heat exchange component. The heat exchange process and the extraction cooling process can be carried out simultaneously or successively, which can be set as needed.

During the collection and storage of the coffee liquid, the collection and storage temperature of the coffee liquid is determined, and a first cooling plate is controlled based on the temperature to cool a bottom support plate in the cup holder assembly, so that the coffee liquid in the coffee cup on the bottom support plate is stabilized at a required temperature. During the process, the temperature sensor is used to detect a temperature of the coffee liquid in the coffee cup in real time, or the temperature sensor is used to detect a temperature of the bottom support plate in real time, and the temperature of the bottom support plate is used to represent the temperature of the coffee liquid. After the temperature is obtained, a control system of the main PCB is used to achieve closed-loop control on a temperature of the first cooling plate.

The motor PCB drives the liquid flowing through the water cooling circuit with the first heat exchange component to circulate by the first water pump, so as to perform heat exchange on the first cooling plate by the first heat exchange component. The heat exchange process and the storage cooling process for the coffee liquid can be carried out simultaneously or successively, which can be set as needed.

Preferably, in the above two water cooling circulation processes, the water pumps are speed-adjustable water pumps. The temperatures of the hot ends of the first cooling plate and the second cooling plate are detected to adjust flow velocities of the water pumps in real time, so as to meet different heat dissipation and cooling requirements.

It should be understood that those of ordinary skill in the art can make improvements or transformations based on the above description, and all such improvements and transformations should fall within the scope of protection of the appended claims of the present disclosure.

The patent for the present disclosure is exemplarily described above with reference to the accompanying drawings. Obviously, the implementation of the patent for the present disclosure is not limited by the above way. As long as various improvements are made using the method concept and technical solution of the patent for the present disclosure, or the concept and technical solution of the patent for the present disclosure are directly applied to other occasions without improvement, they are all within the scope of protection of the present disclosure.

What is claimed is:

1. An efficient cold-brewed coffee device, comprising a base, wherein the base is provided with:
an extraction assembly connected to an extraction water path, wherein the extraction water path is connected to one or more second heat exchange devices, and the second heat exchange device is configured to perform heat exchange and cooling on liquid in the extraction water path and dissipate heat after heat exchange by means of water cooling; and
a cup holder assembly comprising a first heat exchange device configured to perform heat exchange and cooling on a coffee cup on the cup holder assembly and dissipate heat after heat exchange by means of water cooling.

2. The efficient cold-brewed coffee device according to claim 1, wherein the second heat exchange device comprises a refrigeration component and a second cooling plate, the extraction water path passes through the refrigeration component, the refrigeration component is connected to a cold end of the second cooling plate and is configured to cool the liquid in the extraction water path by the second cooling plate, and a hot end of the second cooling plate is connected to a water cooling circuit.

3. The efficient cold-brewed coffee device according to claim 2, wherein the water cooling circuit is provided with a second heat exchange component, and the second heat exchange component is connected to the hot end of the second cooling plate and is configured to absorb heat of the second cooling plate.

4. The efficient cold-brewed coffee device according to claim 1, wherein the first heat exchange device comprises a first cooling plate, a cold end of the first cooling plate is connected to a bottom support plate of the cup holder assembly and is configured to cool the bottom support plate by the first cooling plate, and a hot end of the first cooling plate is connected to a water cooling circuit.

5. The efficient cold-brewed coffee device according to claim 4, wherein the water cooling circuit is provided with a first heat exchange component, and the first heat exchange component is connected to the hot end of the first cooling plate and is configured to absorb heat of the first cooling plate.

6. The efficient cold-brewed coffee device according to claim 1, wherein the base is provided with a cooling water tank;
a water cooling circuit in the first heat exchange device is connected in series to a water cooling circuit in the second heat exchange device, and two ends of a circuit are connected to a water outlet connector and a water inlet connector of the cooling water tank;
alternatively, the water cooling circuit in the first heat exchange device is connected in parallel to the water cooling circuit in the second heat exchange device, so that two ends of the water cooling circuit in the first heat exchange device are connected to the water outlet connector and the water inlet connector of the cooling water tank, and two ends of the water cooling circuit in the second heat exchange device are connected to the water outlet connector and the water inlet connector of the cooling water tank.

7. The efficient cold-brewed coffee device according to claim 6, wherein the cooling water tank comprises an outlet water tank and an inlet water tank, the outlet water tank is connected to a cold water inlet of the water cooling circuit in the first heat exchange device and a cold water inlet of the water cooling circuit in the second heat exchange device, and the inlet water tank is connected to a hot water outlet of the water cooling circuit in the first heat exchange device and a hot water outlet of the water cooling circuit in the second heat exchange device.

8. A cold brew cooling method for an efficient cold-brewed coffee device, wherein based on the efficient cold-brewed coffee device according to claim 1, the cold brew cooling method comprises:
during extraction, cooling liquid in an extraction water path by a second heat exchange device to an extraction temperature; and during collection and storage of coffee liquid, cooling a coffee cup on a cup holder assembly by a first heat exchange device to a storage temperature.

9. The cold brew cooling method for an efficient cold-brewed coffee device according to claim 8, wherein during the extraction, the extraction temperature is determined, and a second cooling plate is controlled based on the extraction temperature to cool liquid flowing through a refrigeration component, so that the liquid in the extraction water path reaches a required temperature; and meanwhile, liquid flowing through a water cooling circuit with a second heat exchange component is driven to circulate, so as to perform heat exchange on the second cooling plate by the second heat exchange component.

10. The cold brew cooling method for an efficient cold-brewed coffee device according to claim 8, wherein during the collection and storage of the coffee liquid, the collection and storage temperature of the coffee liquid is determined, and a first cooling plate is controlled based on the temperature to cool a bottom support plate in the cup holder assembly, so that the coffee liquid in the coffee cup on the bottom support plate is stabilized at a required temperature; and meanwhile, liquid flowing through a water cooling circuit with a first heat exchange component is driven to circulate, so as to perform heat exchange on the first cooling plate by the first heat exchange component.
